(19) United States
(12) Patent Application Publication
(10) Pub. No.: US 2025/0391212 A1
(43) Pub. Date: Dec. 25, 2025

(54) VEHICLE TRACKING AND MONITORING WITH IMMUTABLE IDENTITY PROFIILE

(71) Applicant: International Business Machines Corporation, Armonk, NY (US)

(72) Inventors: DEEPA JAIN, Gurgaon (IN); VenkataBalagopal Thotakura, Hyderabad (IN)

(21) Appl. No.: 18/752,935

(22) Filed: Jun. 25, 2024

(51) Int. Cl. G07C 5/08; G06V 10/75; G06V 10/98; G06V 20/60

(52) U.S. Cl. CPC G07C 5/0816; G06V 10/751; G06V 10/993; G06V 20/60; G06V 2201/08

(57) ABSTRACT

Techniques are described with respect to a system, method, and computer program product for managing a vehicle identity. An associated method includes generating a vehicle profile associated with a vehicle based on a first received image of the vehicle wherein generating the vehicle profile comprises generating a micro-pattern associated with the vehicle based on at least one analysis of the first received image. The associated method further includes detecting one or more modifications of the vehicle based on an analysis of a second received image of the vehicle and transmitting an alert based on the one or more modifications indicating an anomaly associated with the micro-pattern.

### BACKGROUND

This disclosure relates generally to the field of vehicle tracking and monitoring, and more particularly to utilizing artificial intelligence mechanisms to manage vehicular immutable identity profiles.

Vehicles and other applicable means of transportation acquire modifications internally and externally over time due to utilization, road conditions, weather, accidents, and the like. In addition, vehicles are popular candidates for theft and stripping resulting in a difficult process for vehicle owners to track and recover stolen vehicles and/or derived parts.

Various mechanisms are able to monitor vehicles, such as computer vision systems in which digital images, videos, and other visual inputs associated with a vehicle are analyzed in order to perform various functions such as identification, security, surveillance, and the like. Internal and external features of the vehicle are not only able to be detected, but also analyzed for modifications allowing indications of misuse, misappropriation, etc. of the vehicle to be ascertained. These modifications need to be managed in an immutable manner, such as a secure distributed ledger, in order for integrity of the tracked modifications to be maintained by applicable parties (e.g., law enforcement, department of motor vehicles, etc.).

### SUMMARY

Additional aspects and/or advantages will be set forth in part in the description which follows and, in part, will be apparent from the description, or may be learned by practice of the invention.

A system, method, and computer program product for managing a dynamic digital vehicle identity is disclosed herein. In some embodiments, a computer-implemented method for managing a dynamic digital vehicle identity comprises generating a vehicle profile associated with a vehicle based on a first received image of the vehicle; wherein generating the vehicle profile comprises generating, by the computing device, a micro-pattern associated with the vehicle based on at least one analysis of the first received image; detecting one or more modifications of the vehicle based on an analysis of a second received image of the vehicle; and transmitting an alert based on the one or more modifications indicating an anomaly associated with the micro-pattern.

### BRIEF DESCRIPTION OF THE DRAWINGS

These and other objects, features and advantages will become apparent from the following detailed description of illustrative embodiments, which is to be read in connection with the accompanying drawings. The various features of the drawings are not to scale as the illustrations are for clarity in facilitating the understanding of one skilled in the art in conjunction with the detailed description. In the drawings:

FIG. 1 illustrates a networked computer environment, according to an exemplary embodiment;

FIG. 2 illustrates a block diagram of a vehicle identity management system environment, according to an exemplary embodiment;

FIG. 3 illustrates a block diagram of various modules associated with the vehicle identity management system of FIG. 2, according to an exemplary embodiment;

FIG. 4 illustrates a vehicle profile associated with the vehicle identity management system of FIG. 2, according to an exemplary embodiment;

FIG. 5 illustrates a monitored vehicular micro-pattern associated with a vehicle monitoring system, according to an exemplary embodiment; and

FIG. 6 illustrates an exemplary flowchart depicting a method for managing a vehicle identity, according to an exemplary embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. Those structures and methods may, however, be embodied in many different forms and should not be construed as limited to the exemplary embodiments set forth herein. Rather, these exemplary embodiments are provided so that this disclosure will be thorough and complete and will fully convey the scope to those skilled in the art. In the description, details of well-known features and techniques may be omitted to avoid unnecessarily obscuring the presented embodiments.

The terms and words used in the following description and claims are not limited to the bibliographical meanings, but are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e., is a computer-implementable method. The various steps of the method therefore reflect various parts of a computer program, e.g., various parts of one or more algorithms.

Also, in the context of the present application, a system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The following described exemplary embodiments provide a method, computer system, and computer program product for managing a vehicle identity. Vehicles are among some of the most coveted assets which generally require maintenance, upkeep, upgrades, and the like. However, vehicles may be unique and are also frequently subject to theft, in which it is very difficult to track and locate a stolen vehicle and if it is ever recovered its actual and sentimental value may be impacted perpetually. Various features associated with a vehicle may render it unique such as, but not limited make, model, color, upgrades, etc. Artificial intelligence-based techniques, such as computer vision, enable computers and systems to derive meaningful information from digital images, videos, and other visual inputs and then take actions or make recommendations based on that information. This can be extremely useful when tracking and monitoring a vehicle, but also when accounting for modifications to the vehicle internally and/or externally that otherwise indicate unusual and/or unprecedented activities. Therefore, the present embodiments have the capacity to provide a system not only configured to utilize artificial intelligence techniques to analyze internal/external vehicular features along with monitoring of the applicable vehicle, but also optimize the tracking and monitoring of vehicles and their attributes in a secure and privatized manner. In addition, the present embodiments further have the capacity to generate a vehicle profile comprising a micro-pattern, in which the micro-pattern accounts for one or more modifications associated with the vehicle over a period of time and is able to be maintained on distributed ledger in a manner that reduces the amount of computing resources otherwise necessary.

As described herein a “vehicle” may be an automobile, motorcycle, scooter, bicycle, aerial unmanned vehicle (AUV), and any other applicable means of transportation known to those of ordinary skill in the art. It should be noted that for the purpose of the disclosure the present invention may be applied to managing other assets of value including, but not limited to jewelry, property, clothing, and the like.

As described herein a “micro-pattern” is a derivative of media content (e.g., image, sound, video, etc.) associated with a vehicle in which the derivative is acquired by at least one interaction between the vehicle and an applicable sensor. Sensors as described herein may include, but is not limited to cameras, microphones, position sensors, gyroscopes, accelerometers, pressure sensors, cameras, microphones, temperature sensors, biological-based sensors (e.g., heartrate, biometric signals, etc.), a bar code scanner, an RFID scanner, an infrared camera, a forward-looking infrared (FLIR) camera for heat detection, a time-of-flight camera for measuring distance, a radar sensor, a LiDAR sensor, a temperature sensor, a humidity sensor, a motion sensor, internet-of-things (“IoT”) sensors, or any other applicable type of sensors known to those of ordinary skill in the art.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

It is further understood that although this disclosure includes a detailed description on cloud-computing, implementation of the teachings recited herein are not limited to a cloud-computing environment. Rather, embodiments of the present invention are capable of being implemented in conjunction with any other type of computing environment now known or later developed.

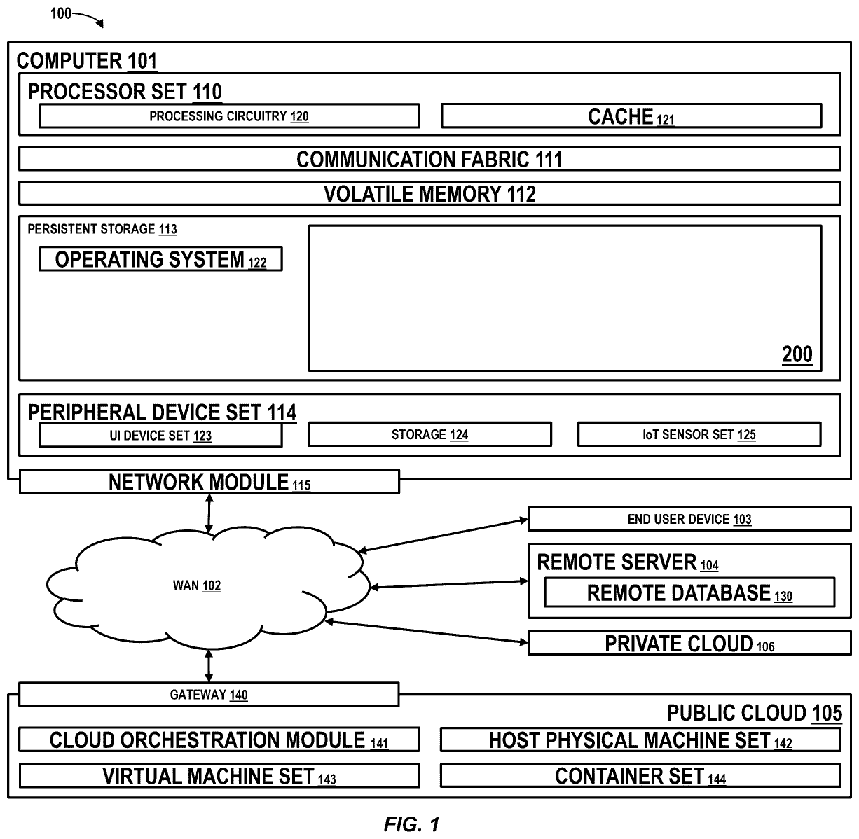

The following described exemplary embodiments provide a system, method, and computer program product for optimizing a virtual avatar. Referring now to FIG. 1, a computing environment 100 contains an example of an environment for the execution of at least some of the computer code involved in performing the inventive methods, such as system 200. In addition to system 200, computing environment 100 contains an example of an environment for the execution of at least some of the computer code involved in performing the inventive methods. Computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and system 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, computer-mediated reality device (e.g., AR/VR headsets, AR/VR goggles, AR/VR glasses, etc.), mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) payment device), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD payment device. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter payment device or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

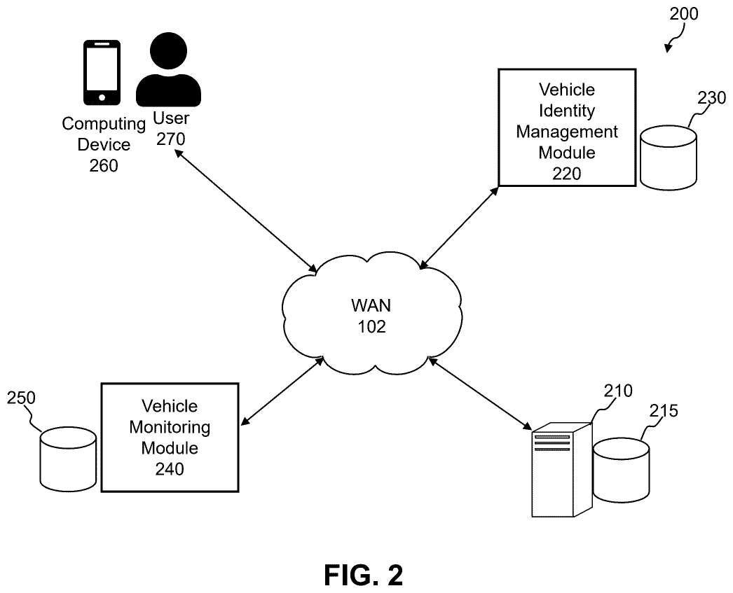

Referring now to FIG. 2, a functional block diagram of a networked computer environment illustrating a computing environment for an vehicle identity management system 200 (hereinafter “system”) comprising a server 210 communicatively coupled to a database 215, a vehicle identity management module 220 communicatively coupled to a vehicle identity management module database 230, a vehicle monitoring module 240 communicatively coupled to a vehicle monitoring module database 250, and a computing device 260 associated with a user 270, each of which are communicatively coupled over WAN 102 (hereinafter “network”) and data from the components of system 200 transmitted across the network is stored in database 215. It should be noted that computing device 260 may be a system integrated and/or associated with a vehicle-based system comprising a vehicle and/or a vehicle monitoring system (e.g., computer vision system, Closed Circuit Television system, and the like). For example, computing device 260 comprises one or more sensors configured to receive sensor data associated with internal and external elements of a vehicle for analyses by vehicle identity management module 220 and/or vehicle monitoring module 240.

Vehicle identity management module 220 is tasked with managing various data associated with the applicable vehicle in addition to generating and maintaining the vehicle profile comprising one or more micro-patterns associated with the vehicle. In some embodiments, vehicle identity management module 220 is communicatively coupled to one or more sensor systems enabling vehicle identity management module 220 to receive sensor data associated with the vehicle along with other applicable vehicular-related data from third-party internet-based sources crawled by web-crawlers associated with server 210. For example, internal and external features and conditions associated with the vehicle (e.g., air quality, temperature, fuel levels, average speed, vehicular analytics, dirt-level, dents/cracks, etc.) and vehicular-related data (e.g., vehicle identification number, license plate number, citations, etc.) ascertained from sources such as but not limited to the Department of Motor Vehicles, law enforcement agencies, and the like for storage and retrieval from database 215 and/or vehicle identity management module database 230. Vehicle identity management module 220 is also tasked with performing fingerprinting of the vehicle in which deep learning, image processing, and other applicable artificial intelligence-based techniques are utilized in order to ascertain external features/conditions associated with the vehicle such as but not limited to vehicle color, vehicle design/infrastructure, cracks, blips, scratches, and the like. The fingerprinting may be utilized for the purpose of correlating the license plate, vehicle identification number, and other applicable vehicular information to the aforementioned internal/external features ultimately resulting in one or more micro-patterns being generated for the applicable vehicle.

Vehicle monitoring module 240 is tasked with consistently monitoring for anomalies associated with the vehicle in addition to accounting for the vehicular-related modifications in a manner that maintains security and privacy. More particularly, once anomalies are detected then vehicle monitoring module 240 is able to take into consideration contextual information, the applicable vehicle profile, vehicular-related analytics, and the like in order to determine whether a modification to the vehicle has occurred, in which modifications are stored, managed, and validated on an applicable distributed ledger. In some embodiments, the outputs of the machine learning models operated by vehicle monitoring module 240, anomalies, distributed ledgers, etc. are stored on vehicle monitoring module database 250. In addition, vehicle monitoring module 240 establishes thresholds associated with the applicable vehicular activity, in which if one or more thresholds are exceeded then vehicle monitoring module 240 determines that there is modification associated with the applicable vehicle. For example, in the instance in which it is detected that a vehicle is being driven at an excessive speed over a period of time that is unconventional compared to historical data otherwise ascertained from the vehicle profile, then vehicle monitoring module 240 may detect an anomaly and analyze the anomaly for the purpose of determining whether it is a modification in light of one or more of contextual information, data ascertained from vehicle profile, the micro-patterns, data stored in database 215, vehicle identity management module database 230, and/or vehicle monitoring module database 250 to determine whether modifications to the vehicle have occurred.

Computing device 260 may take the form of a desktop computer, laptop computer, tablet computer, computer-mediated reality device (CMR), smart phone, smart watch or other wearable computer, mainframe computer, vehicle network-based computing device, vehicle to vehicle network system, quantum computer or any other form of computer or mobile device now known or to be developed in the future that is capable of running a program, accessing a network or querying a database. In some embodiments, computing device 260 is a vehicular computer comprising an embedded subscriber identification module (eSIM), configured to communicate with other vehicles in order to ascertain contextual information, and transmit information derived from vehicle identity management module 220 and/or vehicle monitoring module 240 to user 270 on their applicable computing device(s).

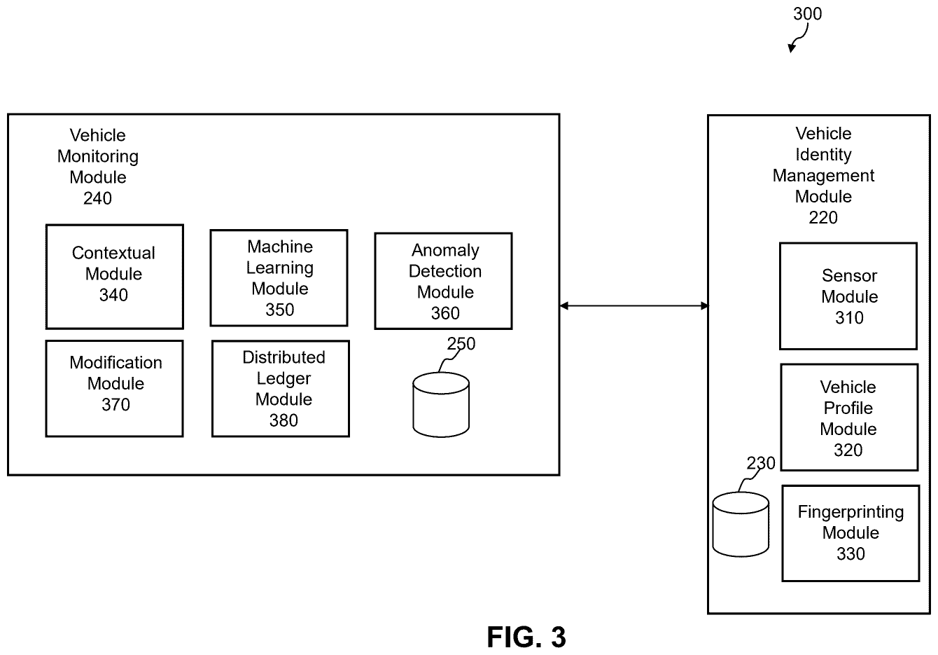

Referring now to FIG. 3, an example architecture 300 of vehicle identity management module 220 and vehicle monitoring module 240 is depicted, according to an exemplary embodiment. In some embodiments, vehicle identity management module 220 comprises sensor module 310, vehicle profile module 320, and fingerprinting module 330. Vehicle monitoring module 240 comprises contextual module 340, machine learning module 350, anomaly detection module 360, modification module 370, and distributed ledger module 380. It should be noted that vehicle identity management module 220 and vehicle monitoring module 240 are communicatively coupled over the network allowing for outputs and/or analyses performed by each respective module to be utilized in applicable training datasets to be utilized by applicable machine learning models operated by machine learning module 350 and/or applicable cognitive systems associated with system 200. Vehicle monitoring module 240 ascertains informed consent, with notice of the collection of personal and/or confidential company data, allowing the user to opt in or opt out of processing personal and/or confidential company data. Consent can take several forms. Opt-in consent can impose on the user to take an affirmative action before personal and/or confidential company data is processed. Alternatively, opt-out consent can impose on the user to take an affirmative action to prevent the processing of personal and/or confidential company data before personal and/or confidential company data is processed. Vehicle monitoring module 240 may provide information regarding personal and/or confidential company data and the nature (e.g., type, scope, purpose, duration, etc.) of the processing. Vehicle monitoring module 240 may further provide the user with copies of stored personal and/or confidential company data, and allows the correction or completion of incorrect or incomplete personal and/or confidential company data. Furthermore, vehicle monitoring module 240 allows for the immediate deletion of personal and/or confidential company data.

Sensor data module 310 is designed to collect various sensor data associated with the internal and/or external environment of the applicable vehicle associated with computing device 260, and any other applicable systems associated with user 270 including, but not limited to sensor systems, monitoring systems, computer vision systems, aerial imagery systems, traffic monitoring systems, crowd-sourcing data systems, broadcasting systems, weather monitoring systems, and the like. Due to the volume of sensor data being continuously collected and processed by sensor data module 310, sensor data module 310 is configured to partition and annotate collected sensor data based on the source it is derived from and subsequently store it in vehicle identity management module database 230. In some embodiments, sensor module 310 collects the various sensor data in order to ascertain external and/or internal parameters associated with the vehicle, in which modifications to the aforementioned parameters may serve has indicators that an anomaly has occurred. For example, if historical data associated with the vehicle indicates a particular air quality when the vehicle is operated by user 270 then sensor module 310 detecting a lower air quality indicates that the vehicle is either being operated by an individual that is not user 270 and/or additional occupants are occupying the vehicle. Sensor data acquired by sensor module 310 may include, but is not limited to image data, video data, audio data, LIDAR data, LADAR data, occupant(s) movement-related data, air quality data, ventilation-based data, steering data, trip data, vehicular communication with other applicable computing devices (e.g., RFID, security systems, thermal-based systems, etc.) and/or other applicable ascertainable data associated with the vehicular environment known to those of ordinary skill in the art.

Vehicle profile module 320 is designed to generate and maintain one or more profiles associated with the applicable vehicle, wherein the profile is derived from at least sensor data derived from sensor module 310. In some embodiments, the vehicle profiles may also ascertain relevant data associated with the vehicle from monitoring systems, computer vision-based systems, and internet sourced data ascertained from web-crawlers (e.g., operation manuals for the vehicle, insurance documents, title documents, vehicle registration, warranties, and the like). It should be noted that the vehicle profiles are meant be an accurate and real-time accounting of internal, external, and/or supplemental features associated with the vehicle, in which the aforementioned vehicle features alone and/or in combination contribute to the uniqueness of the vehicle. The vehicle profiles are stored on vehicle identity management module database 230, in which the vehicle profiles are continuously updates based on analyses performed by vehicle monitoring module 240. For example, outputs of one or more machine learning models operated by machine learning module 350 indicating modifications to the vehicle and/or anomalous events are accounted for on the vehicle profiles.

Fingerprinting module 330 is configured to generate fingerprints associated with the vehicle, in which fingerprinting module 330 is design to establish one or more micro-patterns associated with the vehicle that indicate immutable identity. For example, fingerprinting module 330 communicates with vehicle monitoring module 240 in order to ascertain derivatives of media inputs associated with the vehicle by identifying and classifying vehicle features. Subsequently, fingerprinting module 330 correlates the derivatives to the license plate, vehicle identification number, vehicle title, and/or any other applicable vehicular information for the purpose of generating micro-patterns associated with the vehicle. In some embodiments, the tracking and monitoring of the micro-patterns allows vehicle monitoring module 240 to detect indicators of anomalies and events associated with the internal, external, and/or supplemental features of the vehicle. In particular, fingerprinting module 330 performs fingerprinting to associate a micro-pattern with the license plate for the purpose of ultimately identifying the license plate with the applicable vehicle body micro-print, in which if the pattern repeats over the car body then the core repeating block is encoded. In some embodiments, the pattern block can also be converted to a two-dimensional code (i.e., QR code) for faster matching and for IoT/Edge Devices based detection/validation. It should be noted that the two-dimensional code is directly associated with the vehicle for correlating the micro-pattern to the one or more modifications of the internal and external parameters of the vehicle. For example, micro-patterns may assist vehicle monitoring module 240 with determining that the exterior color of the vehicle has changed from black to red, in which vehicle monitoring module 240 communicates with vehicle identity management module 220 in order to determine if there has been a change in possession of vehicle. This determination may take other applicable factors into consideration including but not limited to location information, vehicular patterns (e.g., vehicle speed, driving behavior, etc.), time of day, and any other applicable vehicular-related contextual information known to those of ordinary skill in the art. In some embodiments, the micro-patterns are configured to function as asset management identification keys which may serve as unique and immutable identifiers or signatures for a combination and/or aggregation of vehicular features (e.g., navigation systems, heating/cooling systems, etc.), vehicular-devices, vehicular-resources, and/or permissions (e.g., vehicle modes, vehicular settings that require authorization of user 270, and the like). Furthermore, fingerprinting module 330 is configured to prevent theft, fraud, and other applicable illegal activities due to the fact that the micro-patterns are unique and derived from the sensor data and media inputs associated with internal, external, and/or supplemental vehicular features. For example, sensor data may indicate that the interior of the vehicle comprises abnormal presences compared to usual (e.g., additional occupants, unusual material/substances in the vehicle, abnormal additional weight, etc.) while derivatives of media inputs may indicate a change in the design, content, presentation, etc. of the license plate of the vehicle indicating that there has been tampering with the vehicular features and that the vehicle is being utilized for illegal activity. Thus, the micro-pattern renders the vehicle profile immutable based on the vehicular features that otherwise should not be modified based on the contextual information.

Contextual module 340 is designed to ascertain context associated with the activities, intentions, and environment associated with the vehicle and/or user 270. In some embodiments, contextual module 340 may communicate with machine learning module 350 in order to utilize natural language processing (“NLP”)/linguistics processing, image/media recognition (You Only Look Once, Convolutional neural networks, deep learning, edge detection, etc.), object recognition, user gesture detection techniques, predictive analytics, behavioral classification techniques, and the like in order to ascertain contextual information associated with the vehicle and/or user 270. It should be noted that contextual module 340 further assists with establishing patterns and/or relevant factors necessary in order for anomaly detection module 360 to determine whether an anomaly associated with the vehicle has occurred. For example, contextual information such as, but not limited to time, weather, terrain, traffic, location, duration of usage, sentiment, and any other contextual related information known to those of ordinary skill in the art may be time-stamped with temporal information, and compared to features of the applicable vehicle profile in order to determine whether the vehicle is being utilized for illegal activity. For example, if the vehicle is being driven at unconventional hours and there are one or more denied attempts to gain access to a resource, feature, and/or vehicular element that otherwise requires authorization from user 270, then anomaly detection module 360 is able to identify that an operator who is not user 270 is attempting to utilize the vehicle. Analyses of contextual information may ascertain modifications to the vehicle in the form of dirt, dust, water, mud, grease, ice, etc.; significant tire marks, vehicle coverings (e.g., tarps, exterior color changes, unreported dents/scratches; and the like.

Machine learning module 350 is configured to use one or more heuristics and/or machine learning models for performing one or more of the various aspects as described herein (including, in various embodiments, the natural language processing or image analysis discussed herein). In some embodiments, the machine learning models may be implemented using a wide variety of methods or combinations of methods, such as supervised learning, unsupervised learning, temporal difference learning, reinforcement learning and so forth. Some non-limiting examples of supervised learning which may be used with the present technology include AODE (averaged one-dependence estimators), artificial neural network, back propagation, Bayesian statistics, naive bays classifier, Bayesian network, Bayesian knowledge base, case-based reasoning, decision trees, inductive logic programming, Gaussian process regression, gene expression programming, group method of data handling (GMDH), learning automata, learning vector quantization, minimum message length (decision trees, decision graphs, etc.), lazy learning, instance-based learning, nearest neighbor algorithm, analogical modeling, probably approximately correct (PAC) learning, ripple down rules, a knowledge acquisition methodology, symbolic machine learning algorithms, sub symbolic machine learning algorithms, support vector machines, random forests, ensembles of classifiers, bootstrap aggregating (bagging), boosting (meta-algorithm), ordinal classification, regression analysis, information fuzzy networks (IFN), statistical classification, linear classifiers, fisher's linear discriminant, logistic regression, perceptron, support vector machines, quadratic classifiers, k-nearest neighbor, hidden Markov models and boosting, and any other applicable machine learning algorithms known to those of ordinary skill in the art. Some non-limiting examples of unsupervised learning which may be used with the present technology include artificial neural network, data clustering, expectation-maximization, self-organizing map, radial basis function network, vector quantization, generative topographic map, information bottleneck method, IBSEAD (distributed autonomous entity systems based interaction), association rule learning, apriori algorithm, eclat algorithm, FP-growth algorithm, hierarchical clustering, single-linkage clustering, conceptual clustering, partitional clustering, k-means algorithm, fuzzy clustering, and reinforcement learning. Some non-limiting example of temporal difference learning may include Q-learning and learning automata. Specific details regarding any of the examples of supervised, unsupervised, temporal difference or other machine learning described in this paragraph are known and are considered to be within the scope of this disclosure. Furthermore, machine learning module 350 utilizes computer vision, which is a field of artificial intelligence (AI) that enables computers and systems to derive meaningful information from digital images, videos, and other visual inputs. Machine learning module 350 is configured to generate actions and/or make recommendations relating to the vehicle based on the aforementioned information. In particular, machine learning module 350 trains one or more machine learning models based on data derived from one or more of database 215, vehicle identity management module database 230, and/or vehicle monitoring module database 250 for the purpose of tracking and monitoring the vehicle. In some embodiments, machine learning module 350 utilizes temporal action localization (TAL) to identify the temporal boundaries in media input associated with the vehicle and categorizes the instances of interest comprising the one or more micro-patterns. In particular, the aforementioned approach allows instances of the media input associated with micro-patterns to be prioritized in a manner in which instances of the media input that do not exceed thresholds established by contextual module 340 are filtered out in light of the relevant context associated with the micro-pattern(s). For example, contextual module 340 may prioritize micro-patterns related to various vehicular features such as the license plate, exterior body color, body/coat status (e.g., chips, dents, etc.), and the like, in which machine learning module 350 is instructed to apply thresholds for filtering out instances of the media input that do not pertain to the relevant micro-patterns. Not only does this approach optimize the computer vision techniques for tracking and monitoring vehicular features, but also it reduces the amount computing resources necessary for machine learning module 350 to complete jobs due to the fact that unnecessary instances of media input are filtered out resulting in faster processing speeds and reduction of overall time for jobs. Furthermore, machine learning module 350 also makes decisions on the number of incremental images to be retained in the system between the latest baseline and the previous baseline using GAN-based capabilities for image generation and logical decision making. As a result, faster results are produced and the applicable hardware is optimized due to the significantly reduced amount of processing due to the filtration of unnecessary data not needed for the logical decision making.

In some embodiments, machine learning module 350 is designed to maintain one or more machine learning models dealing with training datasets including data derived from one or more of database 215, vehicle identity management module database 230, vehicle monitoring module database 250, and any other applicable internet-based data source. The one or more machine learning models are designed to generate outputs representing predictions pertaining to one or more of micro-patterns, anomalies, modifications, etc. associated with user 270 and/or the vehicle. For example, a micro pattern of the vehicle paint and other fittings can be identified and stored in vehicle identity management module database 230 at the time of vehicle registration and/or at the dealership, in which one or more machine learning models generate outputs indicating a percentage match threshold for comparing the micro-pattern to subsequent media inputs reflecting the normal wear and tear of the vehicle (e.g., scratches, dents, fading colour). In some embodiments, machine learning module 350 utilizes generative adversarial networks (GANs) for incremental extrapolation to generate the micro-patterns for subsequent comparison to recently acquired sensor data (e.g., media inputs such as images, etc.).

Anomaly detection module 360 is tasked with identifying anomalies associated with the vehicle that indicate unusual and/or illegal activity associated with the vehicle. As described herein, an “anomaly” is an abnormality, novelty, and/or outlier serving as unusual characteristics of occurrences of typical features in unexpected locations and/or moments in time. In some embodiments, anomaly detection module 360 classifies and groups anomalies associated with the vehicle based on the ascertained contextual information, in which anomaly detection module 360 communicates with machine learning module 350 in order to support supervised, unsupervised, and/or semi-supervised learning. In particular, anomaly detection module 360 analyzes the media inputs in order to uncover unexpected events, observe questionable actions, identify unauthorized attempts to access vehicle features, and the like in sequences in order to ascertain time-related data and correlations, resulting in a more comprehensive understanding of the applicable event(s). In some embodiments, anomaly detection module 360 utilizes logical regression comprising multi-modal data fusion techniques on various data ascertained from sensor module 310 and any other applicable data sources for the purpose of modeling the probability of an anomaly based on contextual information. For example, contextual information may indicate that the vehicle is about to be driven through a muddy terrain that will cause one or more vehicular features to become dirty, in which the probability of an anomaly occurring with the relevant micro-patterns pertaining to the exterior and/or coat of the vehicle increases. In some embodiments, anomaly detection module 360 instructs machine learning module 350 to perform filtering of media inputs, such as acquired images of the vehicle from applicable systems, based on a comparison of the first micro-pattern (e.g., fingerprint) of the vehicle derived from the initial media inputs to the subsequent relevant micro-pattern derived from the subsequent media inputs indicating a lack of anomaly.

Modification module 370 is configured to determine if a modification has occurred based on analyses of the media inputs across a time-period and alert the proper parties if the modification indicates the applicable anomaly is associated with the micro-pattern(s). In some embodiments, the one or more modifications determined by modification module 370 serve as indicators that the anomaly exceeds an anomaly threshold established by anomaly detection module 360. The anomaly threshold may be established by a plurality of factors including, but not limited to the contextual information ascertained by contextual module 340, the relevant vehicle profile, vehicle use history, and any other applicable vehicular information known to those of ordinary skill in the art. For example, if analyses of the media inputs results in detection that vehicle is being covered by cloth, covers, tarps, etc.; however, the visible vehicle features (e.g., bumpers, tires, etc.) match the stored images associated with the micro-pattern(s) then anomaly detection module 360 will determine an anomaly has occurred and subsequently modification module 370 establishes that the anomaly threshold has been exceeded. As a result, modification module 370 alerts the proper third parties such as, but not limited to user 270, law enforcement agencies, vehicle/asset monitoring systems, and the like. Furthermore, if micro-pattern cannot be generated, does not match, and/or license details are obscured the applicable third parties are alerted.

Distributed ledger module 380 is tasked with securely storing micro-patterns, vehicular features, modifications, and any other applicable information associated with the vehicle. Distributed ledger module 380 securely stores the history of the micro-patterns which may include not only modifications to the vehicle, but also collisions, accidents, crimes, and any other applicable events that involve the vehicle. It should be noted that distributed ledger module 380 may operate, blockchains, Directed Acyclic Graphs (DAGs), etc. and ensures that the aforementioned data stored on the one or more ledgers cannot be repudiated, tampered with, or the like. Distributed ledger module 380 comprises one or more components of hardware and/or software program code configured for maintaining a secure ledger related to the vehicle. Distributed ledger module 380 may be configured to create a secure ledger related to the status, both present and historical, of various elements of the system. For example, Distributed ledger module 380 may be configured to create a block chain ledger for each of micro-patterns and vehicular features along with the aforementioned correlations thereof. Distributed ledger module 380 may be configured to create and/or maintain a secure ledger that cannot be refuted by any interested party, in which once data is entered into distributed ledger module 380 it may ensure that the data cannot be manipulated, hacked, or otherwise altered. Distributed ledger module 380 may be configured to check to see if previous problems were identified for a particular micro-pattern. If problems are noted, distributed ledger module 380 may check to see if remediation occurred and whether that remediation occurred within a sufficient amount of time.

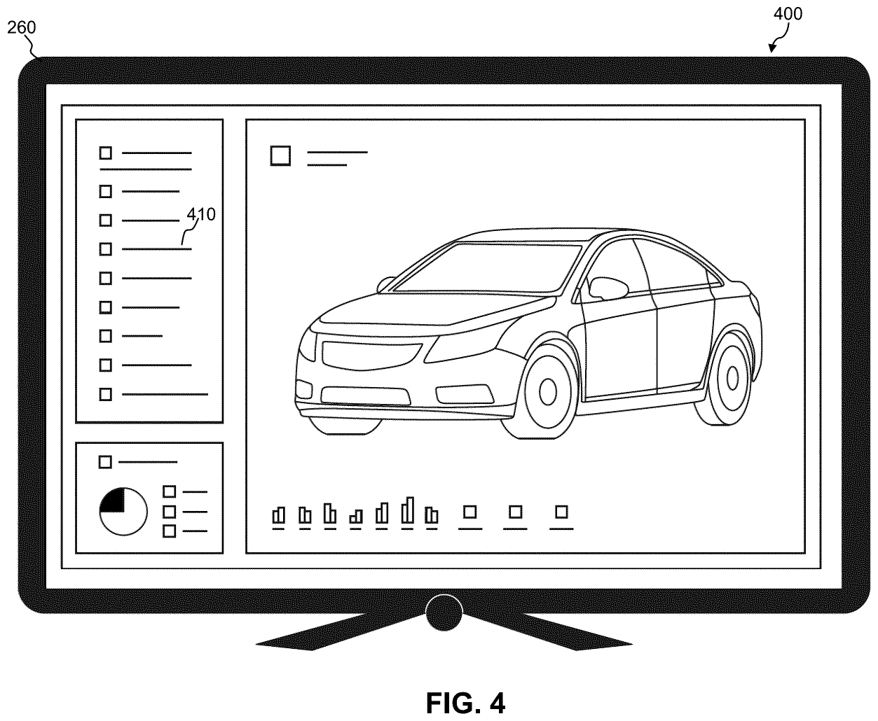

Referring to FIG. 4, a vehicle profile 400 is depicted, according to an exemplary embodiment. It should be noted that vehicle profile 400 is generated based off of data derived from one or more of sensor module 310, database 215, vehicle identity management module database 230, and/or vehicle monitoring module database 250, in which vehicle profile 400 is continuously updated with relevant vehicular data stored on the aforementioned data sources. Although various depictions of vehicle profile 400 are within the spirit and scope of the disclosure, vehicle profile 400 may comprise vehicular analytics 410 which are a derivative of one or more analyses performed on data derived from collected sensor data and data housed within database 215, vehicle identity management module database 230, and/or vehicle monitoring module database 250. For example, initial media inputs may be utilized to establish the baseline micro-patterns/fingerprints associated with the vehicle for the purpose of comparison with analyzed subsequently acquired media inputs. This allows vehicle profile 400 to comprise logs of statuses, modifications, and the like related to vehicular features derived from distributed ledger module 380 which are configured to be interacted with by user 270 via graphical user interfaces over computing device 260 and/or the applicable computing devices associated with the vehicle. Outputs of the one or more machine learning models representing predictions related to vehicular features may be presented to user 270 via alerts on vehicle profile 400. In some embodiments, vehicle profile 400 comprises mechanisms to present the tracking and monitoring of the micro-patterns and correlate vehicular features in real-time allowing user 270 to progressively and incrementally view modifications to vehicular features along with view interactive visual comparisons of the vehicular modifications across a timeline in a simultaneous manner. For example, user 270 may manipulate visual depictions of a vehicular feature presented on computing device 260 side-by-side with the modifications.

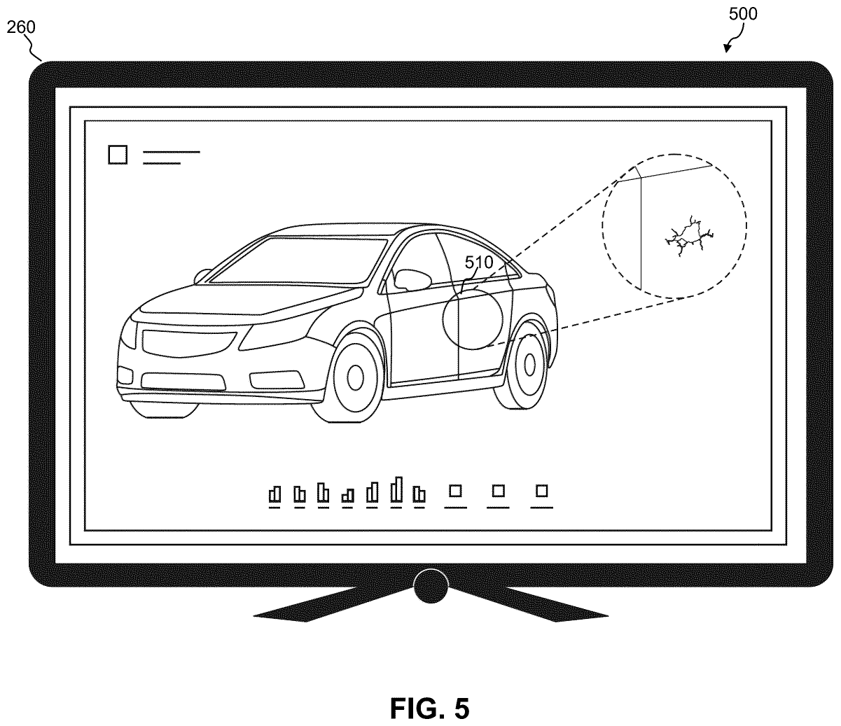

Referring to FIG. 5, a monitored vehicular micro-pattern 500 is depicted, according to an exemplary embodiment. It should be noted that micro-pattern 500 may be used as a baseline reference for the comparison between the initial media input associated with the vehicle and the continuously collected and priority-based filtered subsequent media input in order to ascertain modification 510. As depicted, modification 510 is a crack in the exterior surface of the vehicle which the vehicle has received subsequently to the baseline reference image, in which the initial state of the exterior surface was correlated to a particular micro-pattern and modification 510 is a result of the exterior surface being continuously tracked/monitored. In some embodiments, modification 510 is a result of an anomaly associated with the exterior surface being identified and the anomaly exceeded the anomaly threshold; thus, the anomaly is classified as a modification and correlated to the applicable micro-pattern. The aforementioned allows for continuously tracking and monitoring of other applicable micro-patterns associated with vehicular features to be verified (e.g., VIN, license plate, etc.), in which if one or more of the micro-patterns do not match their previously correlated vehicle feature then the one or more alerts are generated and transmitted to the applicable parties.

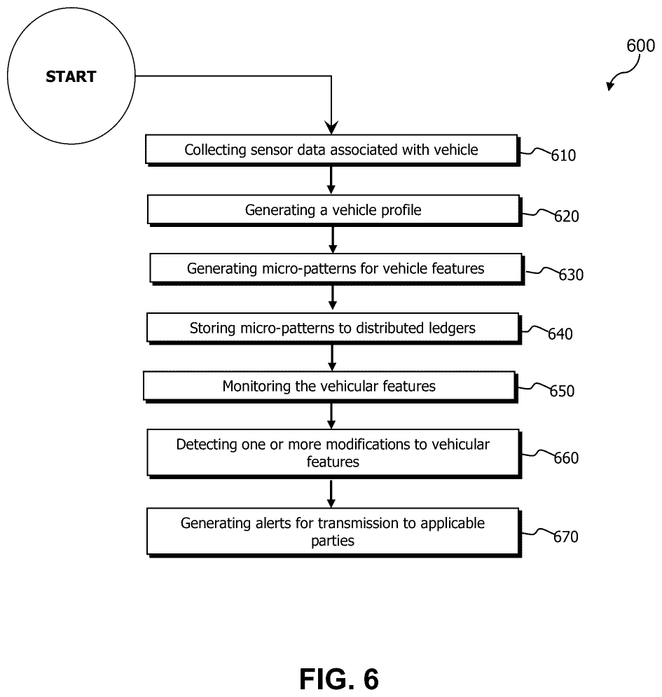

With the foregoing overview of the example architecture, it may be helpful now to consider a high-level discussion of an example process. FIG. 6 depicts a flowchart illustrating a computer-implemented process 600 for managing a vehicle identity, consistent with an illustrative embodiment. Process 600 is illustrated as a collection of blocks, in a logical flowchart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At step 610 of process 600, sensor module 310 collects sensor data associated with the applicable vehicle. Sensor module 310 collects the various sensor data in order to ascertain external and/or internal parameters associated with the vehicle, in which modifications to the aforementioned parameters may serve has indicators that an anomaly has occurred. In some embodiments, sensor data is collected from external systems sensor module 310 is configured to be in communication with including, but not limited to computer vision systems, security systems, closed-circuit television systems (CCTV), and any other applicable systems designed to capture media associated with vehicles known to those of ordinary skill in the art.

At step 620 of process 600, vehicle profile module 320 generates a vehicle profile associated with the applicable vehicle comprising derivatives of sensor data collected by sensor module 310 in addition to other applicable data related to the vehicle ascertained by server 210. The vehicle profiles are stored on vehicle identity management module database 230, in which the vehicle profiles are continuously updates based on analyses performed by vehicle monitoring module 240. For example, outputs of one or more machine learning models operated by machine learning module 350 indicating modifications to the vehicle and/or anomalous events are accounted for on the vehicle profiles. Examples may include, but are not limited to external color change, additional parts added to the interior or exterior of the vehicle, computing device-based functionalities added, and the like.

At step 630 of process 600, fingerprinting module 330 generates the one or more micro-patterns based on the aforementioned collected vehicle features/parameters. Fingerprinting module 330 correlates the derivatives to the license plate, vehicle identification number, vehicle title, and/or any other applicable vehicular information for the purpose of generating micro-patterns associated with the vehicle. The tracking and monitoring of the micro-patterns allows vehicle monitoring module 240 to detect indicators of anomalies and events associated with the internal, external, and/or supplemental features of the vehicle. In particular, fingerprinting module 330 performs fingerprinting to associate a micro-pattern with the license plate for the purpose of ultimately identifying the license plate with the applicable vehicle body micro-print, in which if the pattern repeats over the car body then the core repeating block is encoded.

At step 640 of process 600, distributed ledger module 380 stores the micro-patterns across one or more distributed ledgers. It should be noted that distributed ledger module 380 is configured to create and/or maintain a secure ledger associated with the vehicle and its parameters that cannot be refuted by any interested party, in which once data is entered into distributed ledger module 380 it may ensure that the data cannot be manipulated, hacked, or otherwise altered. Furthermore, one or more distributed ledgers may also be utilized to secure track transfer of ownership of the vehicle and its parameters, in which information such as vehicle title, vehicle registration, driver's license number, and the like may be correlated and hashed to the applicable blocks of the distributed ledgers.

At step 650 of process 600, machine learning module 350 and other applicable modules of system 200 perform monitoring of the applicable vehicle. In some embodiments, machine learning module 350 supports overlaying and extrapolation features. Machine learning module 350 utilizes one or more generative adversarial models to sequentially apply all stored incrementals on the established baseline and extrapolates them to generate a micro-pattern. This can be compared with the latest captured fingerprint to see if they match, in which if they match it adds the current fingerprint as an additional incremental image to the system; thus the additional incremental image becomes the latest. For example, if scratchs, dents, cracks, etc can be identified as islands of areas on the vehicle which do not match the extrapolation amidst all other matched regions of the vehicle, it could be due to a potential accident. Based on the extrapolation exercise and the accident detection output, using one or more machine learning models, machine learning module 350 can make a decision if the latest fingerprint captured is a major deviation from the previous baseline. When determined appropriate, machine learning module 350 may create a new baseline with this fingerprint of the vehicle. Furthermore, machine learning module 350 utilizes the GANs for image generation and logical decision making, allowing decisions on the number of incremental images to be retrained for the models between the latest baseline and the earlier baseline. Subsequently, machine learning module 350 supports auto-cleanup functionality for redundant images, resulting in providing faster results and lead to hardware optimization. In this way, maximum information is retained with minimal storage requirements.

At step 660 of process 600, machine learning module 350 and anomaly detection module 360 detect one or more modifications to the vehicular features. It should be noted that the detection of the modifications may be based off of visible contrasts associated with the previously acquired media inputs and the currently acquired media inputs, or based off of one or more outputs of the machine learning models operated by machine learning module 350 in which the outputs indicate predictions based on one or more of ascertained contextual information, driver behavior, vehicle parameters and the like. In some embodiments, instances of the media input associated with micro-patterns to be prioritized in a manner in which instances of the media input that do not exceed thresholds established by contextual module 340 are filtered out in light of the relevant context associated with the micro-pattern(s). Furthermore, anomaly detection module 360 is configured to learn and differentiate between newer and older vehicles/parts of vehicles due to the fact that machine learning module 350 predicts the vehicle age and distance traveled by running advanced machine learning on the aforementioned databases. For example, if the vehicle traveled 25000 km before a first repolish service, then travelled 15000 km, then received a color change and subsequently traveled 8000 kilometers. The distance traveled is not calculated through GPS or other navigation systems, but through identification of the scratch pattern formation rate over a period of time; thus, the ascertained information can be used by car dealerships, resale, insurance companies, and the like.

At step 670 of process 600, system 200 generates one or more alerts to computing device 260 and any other applicable parties based on the one or more detected modifications exceeding the applicable threshold. In addition to user 270 being alerted, first responders, security systems, and the like receive notifications that an anomaly is occurring associated with the vehicle in order to thwart further negative impact to the vehicle and begin the process of recovery, if applicable.

Based on the foregoing, a method, system, and computer program product have been disclosed. However, numerous modifications and substitutions can be made without deviating from the scope of the present invention. Therefore, the present invention has been disclosed by way of example and not limitation.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-payment devices or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g. light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter payment device or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

It will be appreciated that, although specific embodiments have been described herein for purposes of illustration, various modifications may be made without departing from the spirit and scope of the embodiments. In particular, transfer learning operations may be carried out by different computing platforms or across multiple devices. Furthermore, the data storage and/or corpus may be localized, remote, or spread across multiple systems. Accordingly, the scope of protection of the embodiments is limited only by the following claims and their equivalent.

What is claimed is:

1. A computer-implemented method for managing a dynamic digital vehicle identity, the method comprising:
generating, by a computing device, a vehicle profile associated with a vehicle based on a first received image of the vehicle;
wherein generating the vehicle profile comprises generating, by the computing device, a micro-pattern associated with the vehicle based on at least one analysis of the first received image;
detecting, by the computing device, one or more modifications of the vehicle based on an analysis of a second received image of the vehicle; and
transmitting, by the computing device, an alert based on the one or more modifications indicating an anomaly associated with the micro-pattern.

2. The computer-implemented method of claim 1, wherein the micro-pattern is a unique immutable fingerprint of internal and external parameters of the vehicle; and
wherein a first vehicle fingerprint derived from the first received image is compared to a second vehicle fingerprint derived from the second received image.

3. The computer-implemented method of claim 1, wherein the one or more modifications comprise at least one crack, blip, scratch, color change, license plate change, or abnormal vehicular activity associated with the vehicle.

4. The computer-implemented method of claim 2, wherein detecting one or more modifications comprises:
tracking, by the computing device, the vehicle via a computer visioning system; and
filtering, by the computing device, a plurality of images associated with the vehicle based on the comparison indicating a lack of the anomaly.

5. The computer-implemented method of claim 4, wherein the filtering utilizes a generative artificial intelligence system for incremental image generation and logical decision making;
wherein a first vehicle fingerprint derived from the first received image is compared to a second vehicle fingerprint derived from the second received image.

6. The computer-implemented method of claim 1, wherein the one or more modifications indicating the anomaly is based on the one or more modifications exceeding a threshold associated with the micro-pattern.

7. The computer-implemented method of claim 1, wherein generating the vehicle profile comprises:
generating, by the computing device, a two-dimensional code associated with the vehicle for correlating the micro-pattern to the one or more modifications of the internal and external features of the vehicle.

8. A computer program product for managing a dynamic digital vehicle identity, the computer program product comprising or more computer readable storage media and program instructions collectively stored on the one or more computer readable storage media, the stored program instructions comprising:
program instructions to generate a vehicle profile associated with a vehicle based on a first received image of the vehicle;
wherein the program instructions to generate the vehicle profile further comprise program instructions to generate a micro-pattern associated with the vehicle based on at least one analysis of the first received image;
program instructions to detect one or more modifications of the vehicle based on an analysis of a second received image of the vehicle; and
program instructions to transmit an alert based on the one or more modifications indicating an anomaly associated with the micro-pattern.

9. The computer program product of claim 8, wherein the micro-pattern is a unique immutable fingerprint of internal and external parameters of the vehicle; and
wherein a first vehicle fingerprint derived from the first received image is compared to a second vehicle fingerprint derived from the second received image.

10. The computer program product of claim 8, wherein the one or more modifications comprise at least one crack, blip, scratch, color change, license plate change, or abnormal vehicular activity associated with the vehicle.

11. The computer program product of claim 9, wherein the program instructions to detect one or more modifications further comprise:
program instructions to track the vehicle via a computer visioning system; and
program instructions to filter a plurality of images associated with the vehicle based on the comparison indicating a lack of the anomaly.

12. The computer program product of claim 11, wherein the program instruction to filter further comprise program instructions to utilize a generative artificial intelligence system for incremental image generation and logical decision making;
wherein a first vehicle fingerprint derived from the first received image is compared to a second vehicle fingerprint derived from the second received image.

13. The computer program product of claim 8, wherein the one or more modifications indicating the anomaly is based on the one or more modifications exceeding a threshold associated with the micro-pattern.

14. The computer program product of claim 8, wherein the program instructions to generate the vehicle profile further comprise:
program instructions to generate a two-dimensional code associated with the vehicle for correlating the micro-pattern to the one or more modifications of the internal and external features of the vehicle.

15. A computer system for managing a dynamic digital vehicle identity, the computer system comprising:
one or more processors;
one or more computer-readable memories;
program instructions stored on at least one of the one or more computer-readable memories for execution by at least one of the one or more processors, the program instructions comprising:
program instructions to generate a vehicle profile associated with a vehicle based on a first received image of the vehicle;
wherein the program instructions to generate the vehicle profile further comprise program instructions to generate a micro-pattern associated with the vehicle based on at least one analysis of the first received image;
program instructions to detect one or more modifications of the vehicle based on an analysis of a second received image of the vehicle; and
program instructions to transmit an alert based on the one or more modifications indicating an anomaly associated with the micro-pattern.

16. The computer system of claim 15, wherein the micro-pattern is a unique immutable fingerprint of internal and external parameters of the vehicle; and
wherein a first vehicle fingerprint derived from the first received image is compared to a second vehicle fingerprint derived from the second received image.

17. The computer system of claim 15, wherein the one or more modifications comprise at least one crack, blip, scratch, color change, license plate change, or abnormal vehicular activity associated with the vehicle.

18. The computer system of claim 15, wherein the program instructions to detect one or more modifications further comprise:
program instructions to track the vehicle via a computer visioning system; and
program instructions to filter a plurality of images associated with the vehicle based on the comparison indicating a lack of the anomaly.

19. The computer system of claim 18, wherein the program instruction to filter further comprise program instructions to utilize a generative artificial intelligence system for incremental image generation and logical decision making;
wherein a first vehicle fingerprint derived from the first received image is compared to a second vehicle fingerprint derived from the second received image.

20. The computer system of claim 15, wherein the one or more modifications indicating the anomaly is based on the one or more modifications exceeding a threshold associated with the micro-pattern.
